(19) United States
(12) Patent Application Publication
(10) Pub. No.: US 2026/0194891 A1
(43) Pub. Date: Jul. 9, 2026

(54) INTELLIGENT ALLOY SELECTION FOR FIVE DIMENSIONAL PRINTING

(71) Applicant: INTERNATIONAL BUSINESS MACHINES CORPORATION, Armonk, NY (US)

(72) Inventors: Jeremy R. Fox, Georgetown, TX (US); Martin G. Keen, Cary, NC (US); Alexander Reznicek, Troy, NY (US); Bahman Hekmatshoartabari, White Plains, NY (US)

(21) Appl. No.: 19/008,845

(22) Filed: Jan. 3, 2025

(51) Int. Cl. G05B 19/418

(52) U.S. Cl. CPC G05B 19/41885; G05B 2219/32335; G05B 2219/49243

(57) ABSTRACT

Systems and methods are provided for intelligent alloy selection for five dimensional printing. Structural weaknesses in a target model for five dimensional (5D) printing can be determined, with an artificial intelligence-based controller (AIC), based on strength requirement thresholds of an identified strength requirement of the target model. An alloy infusion strategy can be determined, with the AIC, based on the identified strength requirements and the structural weaknesses in the target model to determine an additive material. The additive material can be infused into a base filament material for the target model to generate an alloy by generating instruction commands for a smart filament extruder based on the alloy infusion strategy while 5D printing. The alloy infusion strategy and the identified strength requirement can be adjusted based on strength ameliorating parameters determined from monitored operational parameters while 5D printing to update the additive material for infusing.

### BACKGROUND

The present invention generally relates to optimizing five dimensional printing, and more particularly to intelligent alloy selection for five dimensional printing.

Five dimensional (5D) printing is a manufacturing technology that uses five-axis printing technique to create complex objects having greater strength and precision compared to three dimensional (3D) printing. The five-axis includes the x, y, z axes and the rotational axes of the x and y axes. As such, complex models can be printed more easily which can use less supports, less materials used, stronger models, higher-quality surfaces and less post-processing.

### SUMMARY

In accordance with an embodiment of the present invention, a computer-implemented method is provided, including, determining, with an artificial intelligence-based controller (AIC), structural weaknesses in a target model for five dimensional (5D) printing based on strength requirement thresholds of an identified strength requirement of the target model, determining, with the AIC, an alloy infusion strategy based on the identified strength requirements and the structural weaknesses in the target model to determine an additive material, infusing the additive material into a base filament material for the target model to generate an alloy by generating instruction commands for a smart filament extruder based on the alloy infusion strategy while 5D printing, and adjusting the alloy infusion strategy and the identified strength requirement based on strength ameliorating parameters determined from monitored operational parameters while 5D printing to update the additive material for infusing.

In accordance with another embodiment of the present invention, a computer system is provided, including, a processor set, one or more computer-readable storage media, and program instructions stored on the one or more computer-readable storage media to cause the processor set to perform operations having, determining, with an artificial intelligence-based controller (AIC), structural weaknesses in a target model for five dimensional (5D) printing based on strength requirement thresholds of an identified strength requirement of the target model, determining, with the AIC, an alloy infusion strategy based on the identified strength requirements and the structural weaknesses in the target model to determine an additive material, infusing the additive material into a base filament material for the target model to generate an alloy by generating instruction commands for a smart filament extruder based on the alloy infusion strategy while 5D printing, and adjusting the alloy infusion strategy and the identified strength requirement based on strength ameliorating parameters determined from monitored operational parameters while 5D printing to update the additive material for infusing.

In accordance with yet another embodiment of the present invention, a computer program product is provided, including, one or more computer-readable storage media, and program instructions stored on the one or more computer-readable storage media to perform operations having, determining, with an artificial intelligence-based controller (AIC), structural weaknesses in a target model for five dimensional (5D) printing based on strength requirement thresholds of an identified strength requirement of the target model, determining, with the AIC, an alloy infusion strategy based on the identified strength requirements and the structural weaknesses in the target model to determine an additive material, infusing the additive material into a base filament material for the target model to generate an alloy by generating instruction commands for a smart filament extruder based on the alloy infusion strategy while 5D printing, and adjusting the alloy infusion strategy and the identified strength requirement based on strength ameliorating parameters determined from monitored operational parameters while 5D printing to update the additive material for infusing.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a flow diagram illustrating a high-level overview of a computer-implemented method for intelligent alloy selection for 5D printing, in accordance with an embodiment of the present invention;

FIG. 2 is a block diagram showing a system for a smart filament extruder, in accordance with an embodiment of the present invention;

FIG. 3 is a block diagram showing a five dimensional printer for intelligent alloy selection for five dimensional printing, in accordance with an embodiment of the present invention;

FIG. 4 is a block diagram showing a system implementing practical applications of intelligent alloy selection for 5D printing, in accordance with an embodiment of the present invention;

FIG. 5 is a block diagram showing an implementation of complex part manufacturing, in accordance with an embodiment of the present invention; and

FIG. 6 is a block diagram showing a computing environment for intelligent alloy selection for five dimensional printing, in accordance with an embodiment of the present invention.

### DETAILED DESCRIPTION

The present embodiments can perform intelligent alloy selection for five dimensional (5D) printing which optimizes the durability and strength of a target model for 5D printing while considering the cost and effectiveness of the potential additive material for alloy infusion.

In an embodiment, structural weaknesses in a target model for five dimensional printing can be determined, with an artificial intelligence-based controller (AIC), based on strength requirement thresholds of an identified strength requirement of the target model. An alloy infusion strategy can be determined, with the AIC, based on the identified strength requirements and the structural weaknesses in the target model to determine an additive material. The additive material can be infused into a base filament material for the target model to generate an alloy by generating instruction commands for a smart filament extruder based on the alloy infusion strategy while 5D printing. The alloy infusion strategy and the identified strength requirement can be adjusted based on strength ameliorating parameters determined from monitored operational parameters while 5D printing to update the additive material for infusing.

Optimized strength and durability in 5D printed objects is a requirement for the successful application of additive manufacturing across various industries. The strength of the printed object determines its functional capabilities, longevity, and ability to withstand diverse environmental and mechanical stresses. Achieving this optimization remains a considerable challenge. The intricacy of designs, varying load-bearing requirements, and diverse use-cases demand a dynamic approach to strength enhancement, one that goes beyond the conventional static approach of using a single type of filament material.

The issue of durability in 5D printed objects is intimately connected with the aspect of strength optimization. Durability refers to the ability of the printed object to resist wear, degradation, and damage over time, while maintaining its intended function and form. This attribute is particularly important for objects intended for long-term use or those exposed to harsh conditions such as high temperatures, corrosion, or mechanical wear and tear.

Despite the impressive capabilities of 5D printing, ensuring the durability of printed objects is a complex task, especially considering the multi-material and multi-dimensional nature of the technology.

In essence, the theme of optimized strength and durability in 5D printed objects is about enhancing the performance and longevity of 5D printed objects while maintaining their functional integrity. This involves balancing the rigidity and flexibility of materials, choosing the right filament material for specific use-cases, and factoring in potential wear and tear scenarios.

The manufacturing industry faces a significant challenge in the domain of additive manufacturing, particularly in 5D printing. The issue centers on the creation of objects with variable strength and durability that can adapt to an array of use-cases.

Traditional printing techniques employ a single type of filament material, which, while effective for uniform applications, falls short in delivering a flexible strength quotient based on varying requirements. This one-size-fits-all approach not only limits the versatility of 5D printing but also risks compromising the structural integrity of the printed objects when subject to non-uniform loads or distinct environmental conditions.

The identification of weak points within a three dimensional (3D) model prior to the printing process remains a largely manual and thus error-prone task. This increases the chances of mechanical failure in the final product, particularly in complex geometric designs. Consequently, businesses and consumers are left to either over-engineer the printed products, leading to unnecessary material consumption and cost escalation, or accept a lower quality product that may not stand up to the intended usage.

The 3D Printing (and 5D Printing) industry struggles with the inability to generate custom alloy filaments dynamically, based on the object's specific strength requirements. This constraint is attributed to the lack of sophisticated systems capable of intelligently determining and injecting suitable alloying elements during the printing process.

Consequently, manufacturers are forced to pre-select a specific type of basic filament, thus compromising the flexibility and adaptability of the printing process to accommodate diverse use-cases. This limitation stifles innovation and reduces the broader applicability of 5D printing technology.

Exemplary applications/uses to which the present invention can be applied include, but are not limited to: automotive customization, complex part manufacturing, aerospace manufacturing.

The present embodiments can optimize the strength and durability of 5D printed objects through the intelligent infusion of various alloys into a base metal filament.

The present embodiments can leverage advanced machine learning algorithms and Internet of Things (IoT) technologies to predict and respond to structural demands in real-time during the printing process.

The present embodiments can use an artificial intelligence-based controller, trained on historical datasets of successful alloy infusions, to identify weak points in the 3D model and determine the infusion strategy for the selected alloys. A network of sensors can monitor the printing process, feeding data back to the artificial intelligence-based controller, allowing for dynamic adjustments to enhance product quality.

This innovative system enables the creation of custom, high-strength 5D printed objects, tailoring the alloy infusion process to specific use-case requirements.

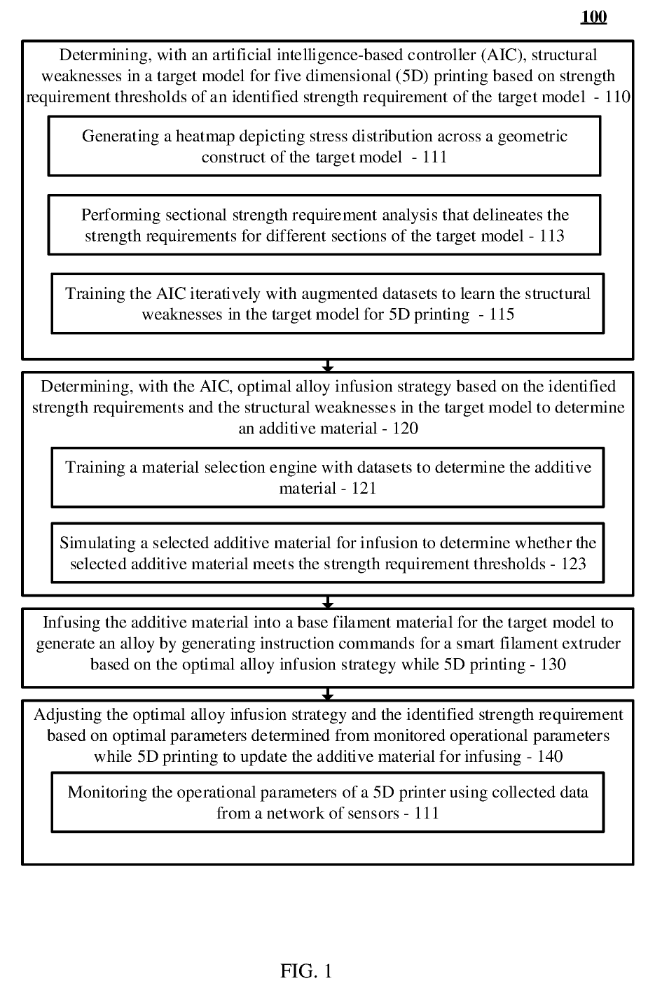

Referring now to the drawings in which like numerals represent the same or similar elements and initially to FIG. 1, a flow diagram illustrating a high-level overview of a computer implemented method for intelligent alloy selection for 5D printing, in accordance with an embodiment of the present invention.

In an embodiment, structural weaknesses in a target model for five dimensional (5D) printing can be determined, with an artificial intelligence-based controller (AIC), based on strength requirement thresholds of an identified strength requirement of the target model. An alloy infusion strategy can be determined, with the AIC, based on the identified strength requirements and the structural weaknesses in the target model to determine an additive material. The additive material can be infused into a base filament material for the target model to generate an alloy by generating instruction commands for a smart filament extruder based on the alloy infusion strategy while 5D printing. The alloy infusion strategy and the identified strength requirement can be adjusted based on strength ameliorating parameters determined from monitored operational parameters while 5D printing to update the additive material for infusing.

In block 110, structural weaknesses in a target model for five dimensional (5D) printing can be determined with an artificial intelligence-based controller.

The target model can include the object to be 5D printed. The target model can include a three dimensional representation of the object to be 5D printed. The target model can also include additional specification on the rotational axes for the x and y axes. The target model can include associated strength requirements for different sections of the object, and a selection of base filament material.

To determine structural weaknesses in the target model for 5D printing, an artificial intelligence-based controller can be employed which can include a comprehensive understanding of the strength requirements of the 5D printing process of the target model. To achieve this, the artificial intelligence-based controller can analyze the 3D model of the object intended for 5D printing through a sophisticated computer-aided design (CAD) software to perform thorough structural analysis that includes simulating loads and constraints (e.g., fixed, pinned, or sliding, etc.), load capacity, material integrity, etc. to reveal potential stress points. The potential stress points are points that can include possible weaknesses where the structure may fail under load.

The CAD software can be used for 3D model analysis and visualization. It can provide application programming interface (API) to extend its capabilities and integrate with other systems. The API can include scripts and add-ins which can be used to automate the process of identifying potential stress areas and creating heatmaps.

In block 111, a heatmap that depicts stress distribution across a geometric construct of the target model can be generated. The results of the analysis can be interpreted as a heatmap depicting stress distribution across the geometric construct of the object. High-stress areas, typically represented in red, draw attention to regions requiring reinforcement. The heatmap can be included in a strength requirement document which delineates the strength requirements for different sections of the target model.

In block 113, a sectional strength requirement analysis that delineates the strength requirements for different sections of the target model can be performed. The sectional strength requirement analysis can also include quantified strength requirements such as stress output (e.g., von Mises stress), deformation, factor of safety, strain, etc. for a given base filament. The sectional strength requirement analysis can include a strength requirement threshold for each quantified strength requirements. For example, for a base filament having iron as material, a stress output for a particular corner can include a quantified strength requirement for the stress output including yield strength A, ultimate tensile strength B, fracture strength C. Each quantified strength requirement can include a strength requirement threshold such as yield strength threshold X, ultimate tensile strength Y, and fracture strength threshold Z. The artificial intelligence-based controller can determine the quantified strength requirements for the base filament and its corresponding strength requirement thresholds, and as such, the artificial intelligence-based controller can determine the additional requirements to meet the corresponding strength requirement thresholds. The quantified strength requirements and their corresponding strength requirement thresholds can be saved and obtained from a database and can be generated into a strength requirement document by the AIC.

The artificial intelligence-based controller can include convolutional neural networks (CNNs) for structural analysis and stress point identification in the 3D model. CNNs are efficient in detecting features in images, which can be extended to analyze 3D models by treating them as 3D images or a sequence of 2D images.

In block 115, the AIC can be trained iteratively with augmented datasets to learn the structural weaknesses in the target model for 5D printing. To learn the structural weaknesses of the target model, the artificial intelligence-based controller can be iteratively trained. A comprehensive collection of 3D models (e.g., obtained through a dataset), previous heatmaps generated, and libraries (e.g., TensorFlow™, Keras™, or PyTorch™) can be utilized to train the artificial intelligence-based controller. The 3D models can include associated strength requirements and past data of successful alloy infusions can serve as the additional training data for the artificial intelligence-based controller. The libraries can provide a flexible platform for machine learning research and development, supporting a wide range of neural network architectures and optimization algorithms.

Cloud platforms (e.g., Google™ AI Platform, Amazon™ SageMaker, or Microsoft™ Azure™ Machine Learning) can be used to provide scalable computational resources, easy-to-use interfaces, and various tools for managing machine learning experiments, reducing the time and effort for training complex models.

To train the artificial intelligence-based controller, the CNNs can be instructed to detect features in the 3D models that typically correlate with elevated strength requirements, such as acute corners or slender walls. Additionally, reinforcement learning (RL) algorithms can be utilized to simulate varying alloy infusion strategies. The environment can include the 5D printer, the base filament, the potential additive material, the printing parameters, identified strength requirement, the target model, etc. The actions of an agent can include selection of additive material based on identified strength requirements. The actions of the agent can include associated rewards based on the resulting strength, durability, and other quantified strength requirements of the currently printed object within the environment. The state of the environment can be measured using the network of sensors, and can include the identified strength and structural weaknesses of the target model. Effective strategies that result in the model meeting strength requirements (e.g., strength requirement thresholds for the quantified strength requirements) are positively reinforced, while less successful strategies are noted for avoidance in the future.

After its initial training, the artificial intelligence-based controller can be fine-tuned with augmented datasets. Techniques like rotation, scaling, or mirroring can be used for expanding the 5D printing datasets and obtain augmented datasets. The artificial intelligence-based controller can be additionally trained with the augmented dataset, which can improve its generalizability by ensuring that the model can perform well on new, unseen data. In another embodiment, the data augmentation techniques can be applied to collected data to further augment the training datasets.

In block 120, alloy infusion strategy based on identified strength requirements and the structural weaknesses in the target model can be determined with the artificial intelligence-based controller.

The alloy infusion strategy can include an appropriate metal selected to infuse with the base filament material to meet the strength requirements and compensate for the structural weaknesses in the target model. The alloy infusion strategy also includes physical properties of the selected metal such as weight, temperature, etc. The artificial intelligence-based controller can also utilize a material analysis engine.

The material analysis engine can act as a knowledgeable assistant, that can guide the artificial intelligence-based controller through a comprehensive library of metals, helping the model pinpoint potential metals capable of meeting the strength requirements when alloyed with the base filament. The selection of metals to be infused into the base filament will largely depend on the requirements of the object being printed, the specific characteristics of the base filament, and the characteristics of the additional metals.

To identify the ideal metal for infusion, the hardness, tensile strength, and corrosion resistance of each metal can be analyzed. This can be seen as a screening phase, determining the most suitable metals to reinforce the base filament. The potential metals can include Titanium, Copper, Aluminum, Nickel, Zinc, Silver, Gold, Iron, etc. The system autonomously chooses the most compatible metal inputs. Practical factors such as cost and availability are also taken into account in addition to performance based on the quantified strength requirements.

In block 121, the material selection engine can be trained with datasets to determine the additive material. The material selection engine can be trained on historical data of successful alloy infusions and the resulting strength of the printed objects.

The material selection engine can utilize supervised learning models, such as Support Vector Machines (SVM) or Random Forests, can be used to rank the candidate metals based on their properties and the strength requirements. The material selection engine can utilize decision-making algorithms such as Multi-Criteria Decision Making (MCDM) algorithms such as the Analytic Hierarchy Process (AHP) or the Technique for Order of Preference by Similarity to Ideal Solution (TOPSIS) can be used for the final selection of metals. These algorithms consider multiple criteria (e.g., hardness, tensile strength, corrosion resistance, cost, availability, etc.) and provide a ranking of the options, facilitating the selection of the best overall metals.

In block 123, a selected additive material for infusion can be simulated to determine whether the selected additive material meets the strength requirement thresholds. The material selection engine can include specialized software such as GRANTA™ MI or CES™ Selector. These platforms offer extensive databases of materials and their properties, as well as powerful analytical tools. APIs provided by these platforms can be used to access their databases and functionalities, enabling integration with the system.

The material selection engine can include simulation software such as ANSYS™ or COMSOL™ Multiphysics to simulating the alloy infusion strategies and the resulting strength, including whether the selected additive material can meet the strength requirement thresholds of the target model. These software packages provide robust tools for physical simulations and also offer APIs for integrating with other systems.

In block 130, alloys can be infused into a base filament material for the target model by generating instruction commands for a smart filament extruder based on the alloy infusion strategy while 5D printing.

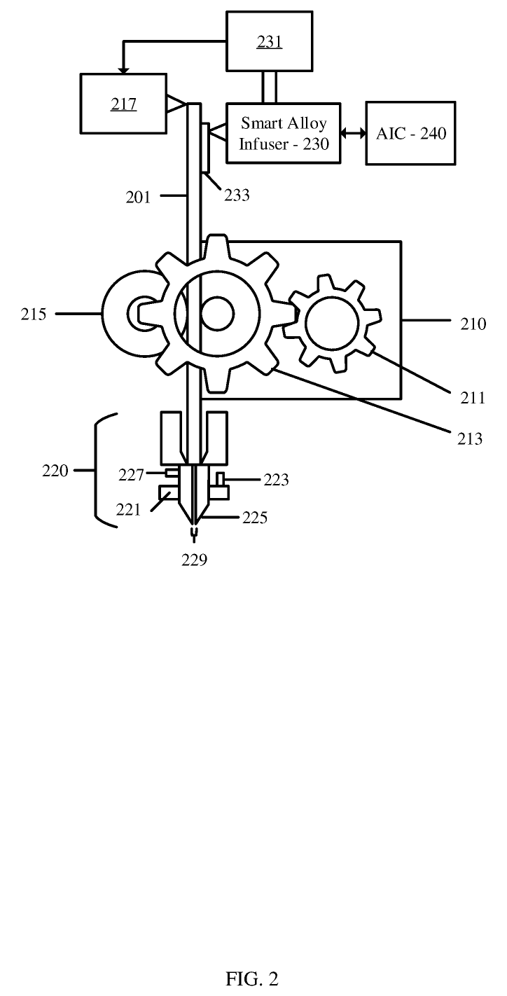

After determining the alloy infusion strategy, alloys can be infused into a base filament material for the target model by generating instruction commands for a smart filament extruder based on the alloy infusion strategy. This is shown in more detail in FIG. 2.

Referring now to FIG. 2, a block diagram showing a system for a smart filament extruder, in accordance with an embodiment of the present invention.

The smart filament extruder 200 can include a stepper motor 210, hot end 220, smart alloy infuser 230. The stepper motor 210 can include a small gear 211, big gear 213, bearing 215. The stepper motor 210 pushes filament material 201 generated by the filament generator 217 through the hot end 220. The filament generator 217 can obtain filament material 201 from the material reservoir 231.

The smart alloy infuser 230 can communicate with the artificial intelligence controller (AIC) 240 that determines the strength requirements and the alloy infusion strategy. The smart alloy infuser 230 can produce an additive material 233 from material reservoir 231 to infuse with the filament material 201. The smart alloy infuser 230 can produce the alloy from the additive material 233 and the filament material 201 based on instruction commands generated by the AIC 240. The instruction commands can include the type of metal, amount of material, temperature of material, temperature requirements to generate an alloy, duration of alloy infusion process, etc.

The hot end 220 can include a thermocouple 223, a heater 221, fusing elements 225. The thermocouple 223 regulates and measures the temperature produced by the heater 221. The heater 221 heats the filament material 201 and the additive material 233 and is pushed through the fusing elements 225 to generate the alloy based on the instruction commands. The heater 221 and the fusing elements 225 can maintain precise temperature control through the thermocouple 223. The fusing elements 225 can produce inert gas through an inert gas chamber 227 that can ensure proper metallic bonding within a fusion area 229.

Referring back now to FIG. 1. In block 140, the alloy infusion strategy can be adjusted based on strength ameliorating parameters determined from monitored operational parameters that ameliorates strengthening of the target model while 5D printing to update the alloys for infusing.

In block 141, operational parameters of a 5D printer can be monitored using collected data from a network of sensors. After the generation of the infused alloy, the 5D printing process is continuously monitored through a network of sensors within the 5D printer. The system continuously monitors the 5D printing process until the 5D printing process finishes. The sensors collect operational parameters (e.g., current filament material, temperature, etc.) and update strength ameliorating parameters from the strength requirements and the alloy infusion strategy. The strength ameliorating parameters can include an updated alloy infusion strategy (e.g., updated alloy) and updated strength requirements (e.g., load, capacity, new weak point, etc.).

For example, after determining weak point A, alloy B is generated to reinforce the base filament material for weak point A. However, weak point C is determined after alloy B has been generated for weak point A. After processing, the AIC 240 determined that alloy D compensates for newly determined weak point C which also considers updated parameters (e.g., weight, capacity, load, cost, etc.) due to the generation of alloy B for weak point A.

The network of sensors also collect strength ameliorating parameters from past alloy infusions to generate datasets for future training. The strength ameliorating parameters can include the metal selected, physical parameters to generate the infused alloy, determined weak points, determined strength requirements, strength thresholds, etc. The strength ameliorating parameters can be stored in a database.

The system can also calibrate the finished model to remove excess material according to the target model specification.

By performing smart alloy infusion, the present embodiments dynamically optimizes the durability and strength of a target model for 5D printing while considering the cost and effectiveness of the potential additive material for alloy infusion.

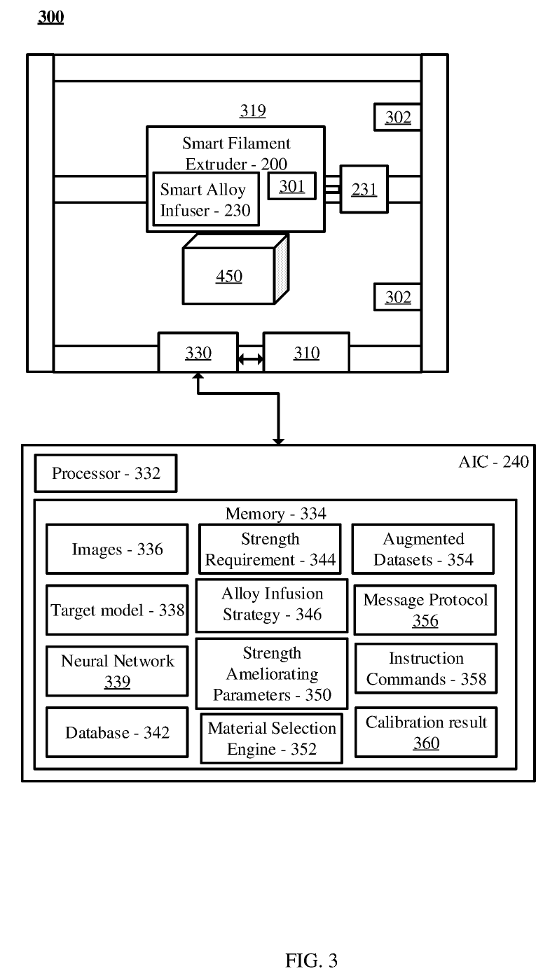

Referring now to FIG. 3, a block diagram showing a five dimensional printer for intelligent alloy selection for five dimensional printing, in accordance with an embodiment of the present invention.

5D printer 300 can include a network of sensors (e.g., embedded sensors 301 and external sensors 302), smart filament extruder 200, the artificial intelligence-based controller (AIC) 240 printing execution module 330, calibration module 310.

The embedded sensors 301 collect data from the operational parameters of the smart filament extruder 200 such as material type, temperature of material, etc. The external sensors 302 collect images 336 regarding the currently printed object 450 and to be transmitted to the AIC 240 to determine the strength requirement 344 and the alloy infusion strategy 346. The network of sensors can communicate using message protocol 356, such as message queuing telemetry transport (MQTT) protocol or constrained application protocol (CoAP), which can be generated and processed by the AIC 240.

The smart filament extruder 200 can generate alloys on determined weak spots within the currently printed object 450 based on the determined strength requirements 344 and the alloy infusion strategy 346 for target model 338. The smart filament extruder 200 can communicate with the printing execution module 330 which can perform instruction commands 358 generated by the AIC 240. The AIC 240 can utilize a material selection engine 352 to determine the additive material for alloy infusion.

While 5D printing, the network of sensors collect images 336 about the current status of the currently printed object 450 to be transmitted to the AIC 240 to continuously determine strength requirement 344 and alloy infusion strategy 346. The strength ameliorating parameters 350 can include the operational parameters, the strength requirement 344, the alloy infusion strategy 346, instruction commands 358, for a successful print. A successful print can occur when the strength parameter thresholds have been met. The strength ameliorating parameters 350 can be saved in the database 342. The strength ameliorating parameters 350 can be included in the augmented datasets 354.

The calibration module 310 can receive a calibration result 360 generated by the AIC 240 from images 336 collected from the currently printed object 450 and compared with the target model 338 to remove excess material from the currently printed object 450 and to determine whether the specification of the target model has been met.

The AIC 240 can continuously monitor the currently printed object 450 and continuously train using additional datasets that include augmented datasets 354. The AIC 240 can retain past learned knowledge using the database 342.

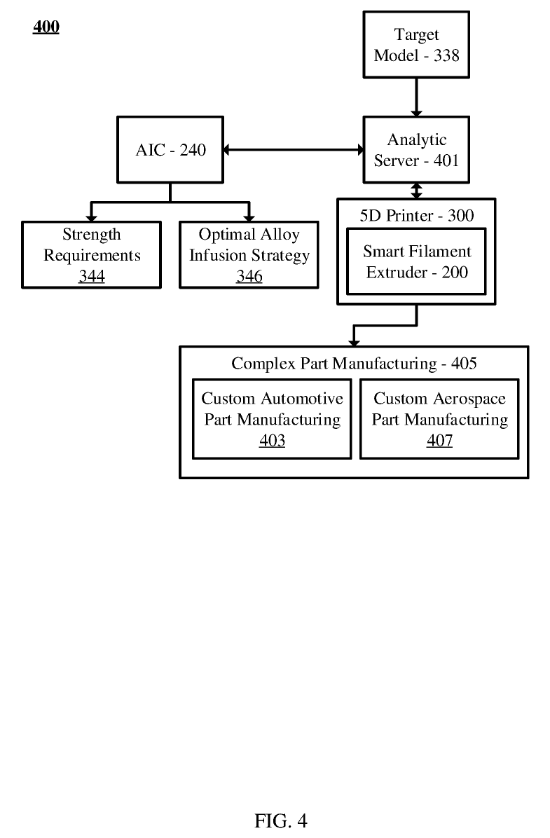

Referring now to FIG. 4, a block diagram showing a system implementing practical applications of intelligent alloy selection for 5D printing, in accordance with an embodiment of the present invention.

In system 400, the target model 388 can be transmitted to an analytic server 401 which can implement the AIC 240. The AIC 240 can determine the strength requirements 344 and alloy infusion strategy 346 of the target model 338. The analytic server 401 can communicate with the 5D printer 300 which can implement the smart filament extruder 200 which can generate additive material to the base filament material to generate an alloy based on the strength requirements 344 and the alloy infusion strategy 346.

The 5D printer 300 can be used for performing various practical applications such as complex part manufacturing 405 that includes custom automotive part manufacturing 403, and custom aerospace part manufacturing 407.

In custom automotive part manufacturing 403, custom parts for vehicles can be generated with 5D printing. However, due to various requirements for various performance requirements of vehicles, different strength requirements and different alloys can be used for such vehicles. For example, a vehicle for typical consumer use can achieve optimum performance with cast iron (e.g., silicon, carbon and iron alloy) for a custom engine block. However, the same vehicle modified for racing can achieve optimum performance with an aluminum-magnesium alloy. 5D printing can be utilized to manufacture the custom engine blocks for both use cases. Additionally, existing engine blocks can be modified or repaired using the present embodiments by infusing the existing engine blocks with alloys based on the determined weak points.

In custom aerospace part manufacturing 407, custom alloy filaments can be determined to generate complex parts for the aerospace industry which can withstand extreme conditions such as high temperatures, pressures, while balancing strength, durability and weight.

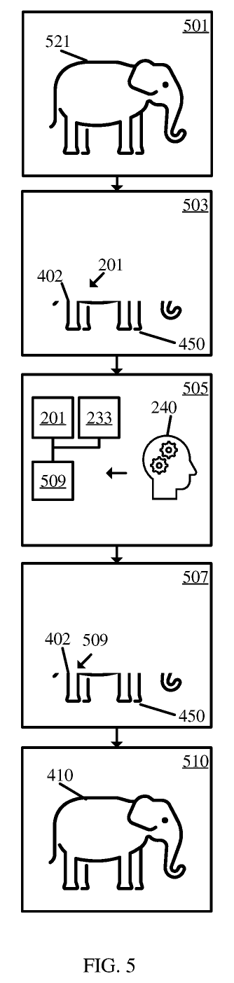

In complex part manufacturing 405, a prototype with intricate designs can be manufactured. This can be shown in more detail in FIG. 5. The prototype can include complex parts that include weak points and varying load-bearing areas.

Referring now to FIG. 5, a block diagram showing a detailed implementation of complex part manufacturing, in accordance with an embodiment of the present invention.

In block 501, a prototype with target model 521 can be obtained from a decision-making entity (e.g., user).

In block 503, the present embodiments can determine weak point 402 within the target model 521. During the printing process, the currently printed object 450 can include determined weak point 402, where a base filament material 201 is being printed on.

In block 505, the AIC 240 can determine the alloy infusion strategy for base filament material 201 to generate alloy 509. The AIC 240 can determine additive material 233 based on the determined strength ameliorating parameters 350 to meet the optimal parameter threshold of the weak point 402.

In block 507, the currently printed object 450 can continue printing for weak point 402 while using alloy 509 by generating instruction commands 358 for the smart filament extruder of the 3D printer 300. While printing, the strength requirements 344 and alloy infusion strategy 346 are updated based on operational parameters collected by the network of sensors.

In block 510, the 5D printing process finishes with the finished printed object 410 that can include multiple weak points 402 that have been strengthened with alloy 509.

In another embodiment, the present embodiments can be utilized for three dimensional printing. In another embodiment, the present embodiments can be utilized for four dimensional printing by using smart materials that change shape, color, or size in response to external stimuli or through passage of time.

Other practical applications are contemplated.

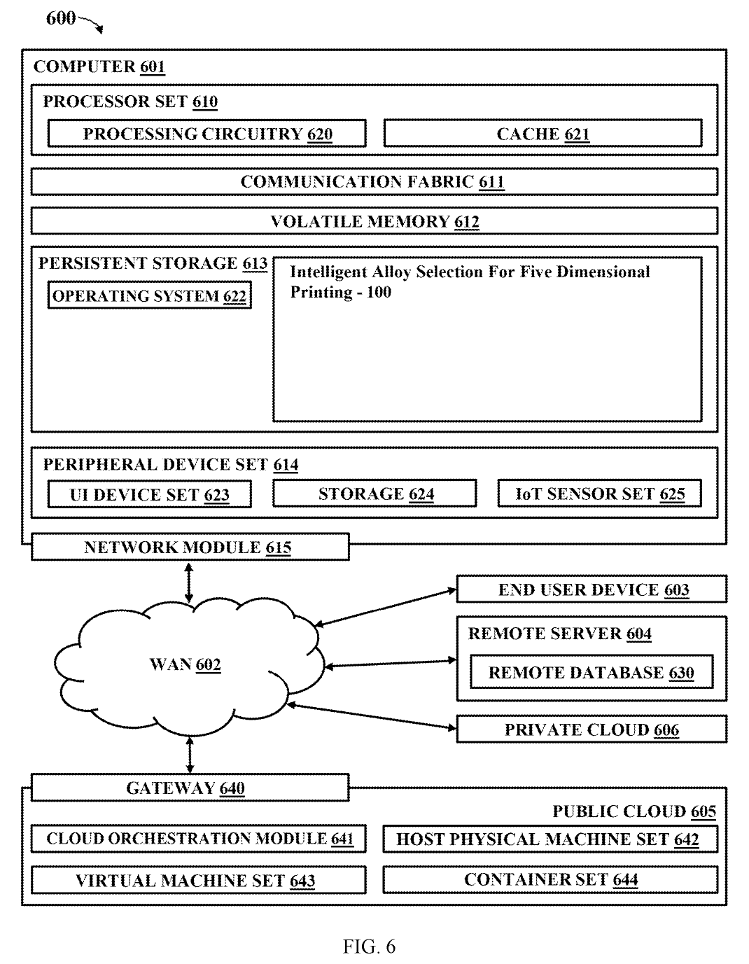

Referring now to FIG. 6, a block diagram showing a computing environment for intelligent alloy selection for five dimensional printing, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as an intelligent alloy selection for five dimensional printing 100. In addition to block 100, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 100, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 100 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices.

Operating system 622 may take several forms, such as various known proprietary operating systems or open source Portable Operating System Interface-type operating systems that employ a kernel. The code included in block 100 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method, comprising:
determining, with an artificial intelligence-based controller (AIC), structural weaknesses in a target model for five dimensional (5D) printing based on strength requirement thresholds of an identified strength requirement of the target model;
determining, with the AIC, an alloy infusion strategy based on the identified strength requirements and the structural weaknesses in the target model to determine an additive material;
infusing the additive material into a base filament material for the target model to generate an alloy by generating instruction commands for a smart filament extruder based on the alloy infusion strategy while 5D printing; and
adjusting the alloy infusion strategy and the identified strength requirement based on strength ameliorating parameters determined from monitored operational parameters while 5D printing to update the additive material for infusing.

2. The computer-implemented method of claim 1, wherein determining the structural weaknesses further comprises generating a heatmap depicting stress distribution across a geometric construct of the target model.

3. The computer-implemented method of claim 1, wherein determining the structural weaknesses further comprises performing sectional strength requirement analysis that delineates the strength requirements for different sections of the target model.

4. The computer-implemented method of claim 1, wherein determining the structural weaknesses further comprises training the AIC iteratively with augmented datasets to learn the structural weaknesses in the target model for 5D printing.

5. The computer-implemented method of claim 1, wherein determining the alloy infusion strategy further comprises training a material selection engine with datasets to determine the additive material.

6. The computer-implemented method of claim 1, wherein determining the alloy infusion strategy further comprises simulating a selected additive material for infusion to determine whether the selected additive material meets the strength requirement thresholds.

7. The computer-implemented method of claim 1, wherein adjusting the alloy infusion strategy further comprises monitoring the operational parameters of a 5D printer using collected data from a network of sensors.

8. A computer system, comprising:
a processor set;
one or more computer-readable storage media; and
program instructions stored on the one or more computer-readable storage media to cause the processor set to perform operations comprising:
determining, with an artificial intelligence-based controller (AIC), structural weaknesses in a target model for five dimensional (5D) printing based on strength requirement thresholds of an identified strength requirement of the target model;
determining, with the AIC, an alloy infusion strategy based on the identified strength requirements and the structural weaknesses in the target model to determine an additive material;
infusing the additive material into a base filament material for the target model to generate an alloy by generating instruction commands for a smart filament extruder based on the alloy infusion strategy while 5D printing; and
adjusting the alloy infusion strategy and the identified strength requirement based on strength ameliorating parameters determined from monitored operational parameters while 5D printing to update the additive material for infusing.

9. The system of claim 8, wherein determining the structural weaknesses further comprises generating a heatmap depicting stress distribution across a geometric construct of the target model.

10. The system of claim 8, wherein determining the structural weaknesses further comprises performing sectional strength requirement analysis that delineates the strength requirements for different sections of the target model.

11. The system of claim 8, wherein determining the structural weaknesses further comprises training the AIC iteratively with augmented datasets to learn the structural weaknesses in the target model for 5D printing.

12. The system of claim 8, wherein determining the alloy infusion strategy further comprises training a material selection engine with datasets to determine the additive material.

13. The system of claim 8, wherein determining the alloy infusion strategy further comprises simulating a selected additive material for infusion to determine whether the selected additive material meets the strength requirement thresholds.

14. The system of claim 8, wherein adjusting the alloy infusion strategy further comprises monitoring the operational parameters of a 5D printer using collected data from a network of sensors.

15. A computer program product, comprising:
one or more computer-readable storage media; and
program instructions stored on the one or more computer-readable storage media to perform operations comprising:
determining, with an artificial intelligence-based controller (AIC), structural weaknesses in a target model for five dimensional (5D) printing based on strength requirement thresholds of an identified strength requirement of the target model;
determining, with the AIC, an alloy infusion strategy based on the identified strength requirements and the structural weaknesses in the target model to determine an additive material;
infusing the additive material into a base filament material for the target model to generate an alloy by generating instruction commands for a smart filament extruder based on the alloy infusion strategy while 5D printing; and
adjusting the alloy infusion strategy and the identified strength requirement based on strength ameliorating parameters determined from monitored operational parameters while 5D printing to update the additive material for infusing.

16. The computer program product of claim 15, wherein determining the structural weaknesses further comprises generating a heatmap depicting stress distribution across a geometric construct of the target model.

17. The computer program product of claim 15, wherein determining the structural weaknesses further comprises performing sectional strength requirement analysis that delineates the strength requirements for different sections of the target model.

18. The computer program product of claim 15, wherein determining the structural weaknesses further comprises training the AIC iteratively with augmented datasets to learn the structural weaknesses in the target model for 5D printing.

19. The computer program product of claim 15, wherein determining the alloy infusion strategy further comprises simulating a selected additive material for infusion to determine whether the selected additive material meets the strength requirement thresholds.

20. The computer program product of claim 15, wherein adjusting the alloy infusion strategy further comprises monitoring the operational parameters of a 5D printer using collected data from a network of sensors.
